(19) United States
(12) Patent Application Publication
(10) Pub. No.: US 2025/0201470 A1
(43) Pub. Date: Jun. 19, 2025

(54) MULTI-WINDING NFC PORT

(71) Applicant: Apple Inc., Cupertino, CA (US)

(72) Inventors: Christopher M Pinciuc, Pebble Beach, CA (US); Ryan J Moynihan, San Francisco, CA (US); Jonathan L Hayes, Los Gatos, CA (US); Mahmoud S Elsharawy, Ithaca, NY (US)

(21) Appl. No.: 18/662,103

(22) Filed: May 13, 2024

Related U.S. Application Data
(60) Provisional application No. 63/611,474, filed on Dec. 18, 2023.

(51) Int. Cl. H01F 27/30; H01F 27/24; H02J 50/10; H04B 5/79

(52) U.S. Cl. CPC H01F 27/306; H01F 27/24; H02J 50/10; H04B 5/79

(57) ABSTRACT

A multiple winding coil can include a magnetic core; a first winding with a first configuration used for communication wound on the magnetic core; and a second winding with a second configuration used for wireless power transfer also wound on the magnetic core. The first winding can include a post winding wound around the magnetic core, and the second winding can include a solenoid winding wound around the magnetic core in a direction orthogonal to a direction of the post winding. The magnetic core can be formed of ferrite. The windings can include wire wound windings and/or printed circuit windings. The magnetic core, first winding, and second winding can have dimensions selected to communicate and transfer power at one or more frequencies associated with a standard, such as an NFC standard by the NFC Forum. The one or more frequencies can include 13.56 MHz.

### CROSS-REFERENCE TO RELATED APPLICATIONS

This application claims priority to U.S. Provisional Patent Application No. 63/611,474, filed Dec. 18, 2023, which is hereby incorporated by reference in its entirety.

### BACKGROUND

Electronic devices, such as smartphones, tablet computers, smart watches, wireless carphones, styluses, etc. may employ wireless power transfer to facilitate charging of batteries within the devices. Electronic devices likewise utilize wireless communication via different protocols for exchanging information between devices for various purposes.

### SUMMARY

Wireless power transfer and wireless communication can provide for convergence opportunities in which certain circuitry, protocols, physical structures, and the like can be combined and/or complement each other so as to be usable for both wireless communication and wireless power transfer. As one example, such combination can reduce the size, cost, and/or complexity of electronic devices by reducing the number of components. One example discussed in greater detail below is combined power and data transfer coil structures that can be used for wireless power transfer and wireless communication, for example using wireless charging and communication as promulgated by the NFC Forum.

A multiple winding coil can include a magnetic core; a first winding with a first configuration used for communication wound on the magnetic core; and a second winding with a second configuration used for wireless power transfer also wound on the magnetic core. The first winding with a first configuration can include a post winding wound around the magnetic core, and the second winding with a second configuration can include a solenoid winding wound around the magnetic core in a direction orthogonal to a direction of the post winding. The magnetic core can be formed of ferrite. At least one of the first and second windings can include wire wound windings or printed circuit windings. The magnetic core, first winding, and second winding can have dimensions selected to communicate and transfer power at one or more frequencies associated with a standard, such as a near field communication (NFC) standards promulgated by the NFC Forum. The one or more frequencies can include 13.56 MHz. The magnetic core, first winding, and second winding can have dimensions selected to communicate and transfer power at one or more frequencies associated with different standards.

A dual-purpose wireless power transfer and communication system configured to communicate and transfer power at one or more frequencies associated with near field communication (NFC) standards promulgated by the NFC Forum can include a magnetic core; a first winding wound about the magnetic core in a post configuration to be used for communication; and a second winding wound about the magnetic core in a post configuration to be used for wireless power transfer; and at least one controller for wireless power transfer and communication coupled to the respective first and second windings. The at least one controller can be a dual input controller having a first input coupled to the first winding and a second input coupled to the second winding. The at least one controller can be a single input controller, and the first and second windings can be coupled to the single input by a switch. The switch can be external to the at least one controller. The magnetic core, first winding, and second winding can be configured to communicate and transfer power at 13.56 MHz. At least one of the first and second windings can include wire wound windings.

An electronic device can include one or more processors that execute a communication application; a power system that includes a dual-purpose wireless power transfer and communication system configured to communicate and transfer power at one or more frequencies associated with near field communication (NFC) standards promulgated by the NFC Forum. The power system can further include a magnetic core; a first winding wound about the magnetic core in a post configuration to be used for communication; and a second winding wound about the magnetic core in a post configuration to be used for wireless power transfer; and at least one controller for wireless power transfer and communication coupled to the respective first and second windings; wherein at least one of the one or more processors and the at least one controller selectively enable and disable the first and second windings to provide communication or power transfer functionality. At least one of the processor and the at least one controller can selectively enable and disable the first and second windings to provide communication or power transfer functionality by: enabling the power winding; upon detecting that a communication feature of an application has started on the processor, enabling the communications winding. Enabling the communications winding can further include disabling the power winding. The controller can selectively enable and disable the first and second windings to provide communication or power transfer functionality by, upon detecting that a communication feature of the application has stopped on the processor, disabling the communications winding and re-enabling the power winding. The electronic device can further include a visual display operatively coupled to the one or more processors, wherein the visual display presents an visual indication that the electronic device is ready to provide communication functionality while the first winding is enabled. At least one of the processor and the at least one controller can selectively enable and disable the first and second windings to provide communication or power transfer functionality by: determining whether a wireless power receiver is present; determining whether a communications application has started on the processor; responsive to determining that a wireless power receiver is present: enabling the power winding; engaging in power transfer; and upon completion of power transfer, disabling the power winding; and responsive to determining that a communication application has started on the processor: enabling the communication winding; engaging in communication; and upon completion of communication, disabling the communication winding. The magnetic core, first winding, and second winding can be configured to communicate and transfer power at 13.56 MHz. The electronic device can be a tablet computer. The wireless power receiver can be a stylus.

### BRIEF DESCRIPTION OF THE DRAWINGS

FIG. 1 illustrates a block diagram of an illustrative wireless power transfer system.

FIGS. 2A-2B illustrate coil configurations for wireless power transfer and/or communication applications.

FIGS. 3A-3C illustrate coil configurations and corresponding flux paths for wireless power transfer and/or communication applications.

FIG. 4 illustrates a multi-winding coil configuration.

FIG. 5A illustrates a multi-winding coil coupled to a two-input controller chip.

FIG. 5B illustrates a multi-winding coil coupled to a single-input controller chip via a switch.

FIG. 6 illustrates a block diagram of an electronic device.

FIG. 7 illustrates a flow chart of a first technique for selecting between a wireless power transfer coil and a wireless communication coil.

FIG. 8 illustrates a flow chart of a second technique for selecting between a wireless power transfer coil and a wireless communication coil.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

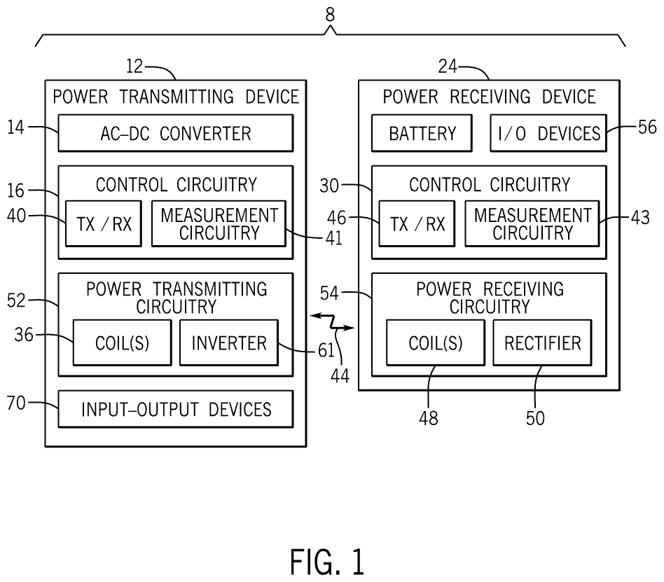

An illustrative wireless power system (wireless charging system) is shown in FIG. 1. Wireless power system 8 can include a wireless power transmitter 12 and a wireless power receiver 24. Wireless power transmitter 12 can include control circuitry 16. Wireless power receiver 24 can include control circuitry 30. The respective control circuitries can be used to control the operation of wireless power system 8. This control circuitry may include processing circuitry associated with microprocessors, power management units, baseband processors, digital signal processors, microcontrollers, and/or application-specific integrated circuits with processing circuits. The processing circuitry can implement desired control and communications features in wireless power transmitter 12 and wireless power receiver 24. For example, the processing circuitry may be used in selecting coils, determining power transmission levels, processing sensor data and other data to detect foreign objects and perform other tasks, processing user input, handling negotiations between wireless power transmitter 12 and wireless power receiver 24, communicating (i.e., sending and receiving in-band and out-of-band data), making measurements, and otherwise controlling the operation of wireless power system 8.

Control circuitry 16, 30 in system 8 may be configured to perform operations using hardware (e.g., dedicated hardware or circuitry), firmware, and/or software. Software code for performing operations in system 8 can be stored on non-transitory computer readable storage media (e.g., tangible computer readable storage media) in the control circuitry. The software code may sometimes be referred to as software, data, program instructions, instructions, and/or code. The non-transitory computer readable storage media may include non-volatile memory such as non-volatile random-access memory (NVRAM), one or more hard drives (e.g., magnetic drives or solid-state drives), one or more removable flash drives, or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors, a central processing unit (CPU), or other processing circuitry, including analog, digital, and/or hybrid circuitry.

Wireless power transmitter 12 and wireless power receiver 24 may each take a variety of forms, including computing devices, portable computing devices (such as such as a wristwatch, a cellular telephone, a laptop computer, a tablet computer, etc.), an accessory such as an earbud, stylus, or other electronic equipment. Wireless power transmitter 12 may be coupled to a wall outlet (e.g., an alternating current power source), may have a battery for supplying power, and/or may have another source of power. Wireless power transmitter 12 may have an alternating-current (AC) to direct-current (DC) power converter such as AC-DC power converter 14 for converting AC power from a wall outlet or other power source into DC power. DC power may be used to power control circuitry 16. During operation, a controller in control circuitry 16 can use power transmitting circuitry 52 to transmit wireless power to power receiving circuitry 54 of wireless power receiver 24. Power transmitting circuitry 52 may have switching circuitry (e.g., inverter circuitry 61 formed from transistors) that is turned on and off based on control signals provided by control circuitry 16 to create AC current signals through one or more wireless power transmitting coils such as wireless power transmitting coil(s) 36. These coil drive signals cause coil(s) 36 to transmit wireless power.

As the AC currents pass through one or more coils 36, alternating-current electromagnetic (e.g., magnetic) fields (wireless power signals 44) are produced that are received by one or more corresponding receiver coils such as coil(s) 48 in wireless power receiver 24. Wireless power receiver 24 may have a single coil 48 or other suitable number of coils 48. When the alternating-current electromagnetic fields are received by coil(s) 48, corresponding alternating-current currents are induced in coil(s) 48. The AC signals that are used in transmitting wireless power may have any suitable frequency. In some embodiments, relatively higher frequencies (e.g., 13.56 MHz for NFC charging) are suitable. In some embodiments, relatively lower frequencies (e.g., 100-200 kHz for Qi charging, 128 kHz, 326 kHz, 360 kHz, 1.7 MHz, 6.78 MHz, so forth) are suitable. Rectifier circuitry such as rectifier circuitry 50, which contains rectifying components such as synchronous rectification metal-oxide-semiconductor transistors arranged in a bridge network, converts received AC signals (received alternating-current signals associated with electromagnetic signals 44) from one or more coils 48 into DC voltage signals for powering wireless power receiver 24. It is noted that the NFC charging standard is specified by the NFC Forum, and that the Qi charging standard is specified by the Wireless Power Consortium.

The DC voltage produced by rectifier circuitry 50 (sometimes referred to as rectifier output voltage Vrect) can be used in charging a battery such as battery 58 and can be used in powering other components in wireless power receiver 24. For example, wireless power receiver 24 may include input-output devices 56. Input-output devices 56 may include input devices for gathering user input and/or making environmental measurements and may include output devices for providing a user with output. Input-output devices 56 may also include sensors for gathering input from a user and/or for making measurements of the surroundings of wireless power system 8. Wireless power transmitter 12 may have one or more input-output devices 70 for similarly gathering user input and/or making environmental measurements and may include output devices for providing a user with output.

Wireless power transmitter 12 and/or wireless power receiver 24 may communicate wirelessly using in-band or out-of-band communications. Wireless power transmitter 12 may, for example, have wireless transceiver circuitry 40 that wirelessly transmits out-of-band signals to and/or receives out-of-band signals from wireless power receiver 24 using an antenna or coil (not shown in FIG. 1), such as an NFC antenna. Wireless power receiver 24 may have wireless transceiver circuitry 46 that transmits out-of-band signals to and/or receives out-of-band signals from wireless power transmitter 12 via an antenna or coil (not shown in FIG. 1), such as an NFC antenna. In some cases, the additional antenna or coil for out-of-band communication may share at least a portion of the structure for power transmission coils 36, 48, as described in greater detail below. In some cases, in-band communication between wireless power transmitter 12 and wireless power receiver 24 may be performed using coils 36 and 48. Either the in-band or out-of-band communications may take place concurrently with power transfer or separately from power transfer. Power transfer and communication may be implemented using a variety of configurations and protocols. In at least some embodiments they can be implemented using NFC (Near Field Communication) charging and/or NFC data transfer according to standards promulgated by the NFC Forum.

It may be desirable for wireless power transmitter 12 and wireless power receiver 24 to be able to communicate information (including but not limited to received power, battery states of charge, etc. to control wireless power transfer) as well as other information to support any of a variety of communication applications. However, at least some such communications need not involve the transmission of personally identifiable information function. Out of an abundance of caution, it is noted that to the extent that any implementation of this charging technology (or other communications beyond those relating to charging/power transfer) involves the use of personally identifiable information, implementers should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users. Moreover, in the case of NFC data communications, implementers should consider industry best practices and security techniques for such communications.

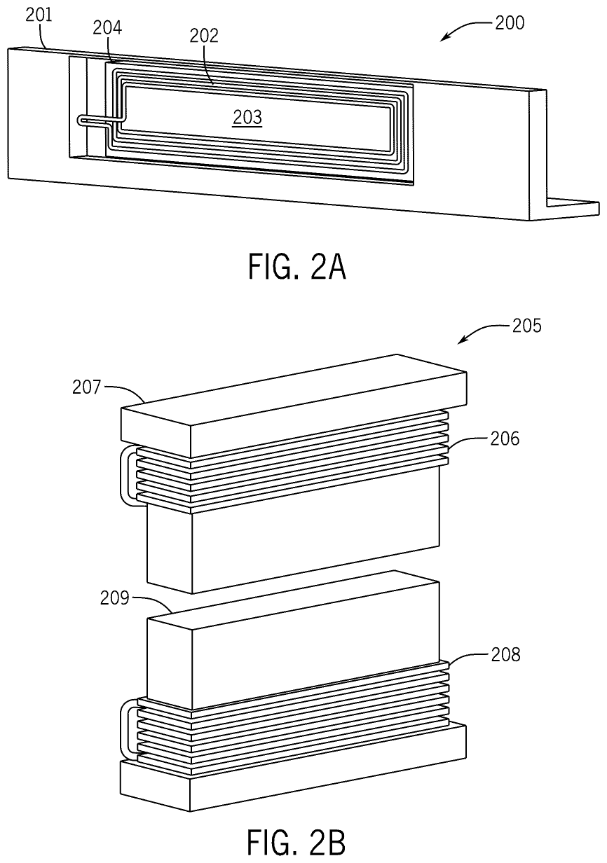

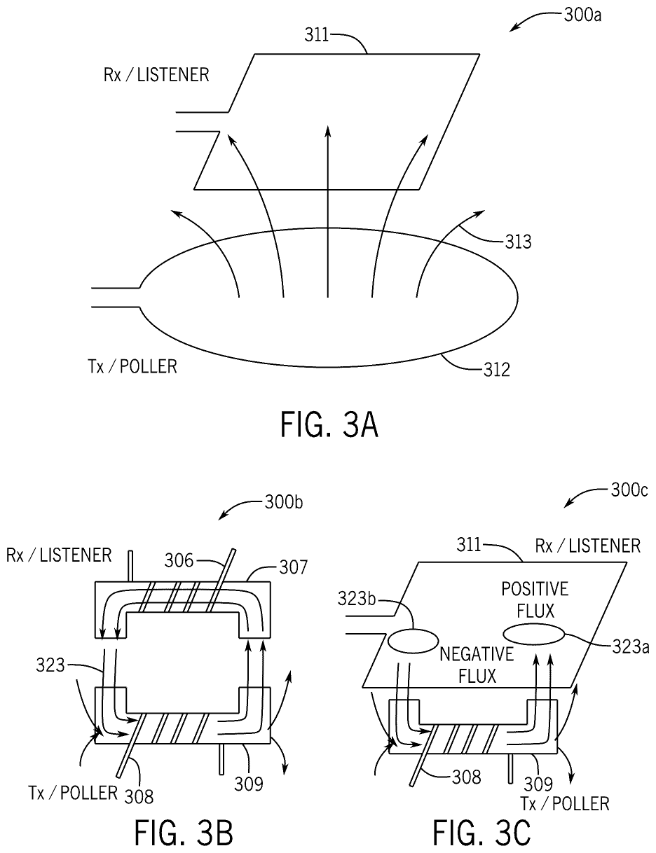

FIGS. 2A-2B illustrate coil configurations for wireless power transfer and/or communication applications. More specifically, FIG. 2A illustrates an example of a planar coil configuration 200. The planar coil configuration 200 can include a coil assembly that may be disposed within a window of a housing 201 of an electronic device. In other embodiments, the coil assembly could be disposed atop the housing, i.e., on an outer surface of the housing, within the housing (provided that the housing is electromagnetically transparent at the frequency (ies) of interest), etc. The coil assembly can include a winding 202 and a magnetic core 203. The magnetic core 203 can be formed of a material having a suitable magnetic permeability to provide for one or more of shielding of other electronic components within housing 201 and/or flux steering with respect to the magnetic flux generated by the winding 202. For example, magnetic core 203 can be made from a wide variety of ferrite materials, which can include ferromagnetic material disposed within a composite matrix otherwise incorporating a ceramic or similar material. Winding 202 can be a wire wound coil, a printed circuit coil, or any other suitable configuration including one or more conductive loops. The dimensions, number of turns, wire size, etc. can be selected based on the operating frequencies and power levels of a particular embodiment. In some embodiments, the coil assembly can be disposed within its own coil housing 204, that can be disposed within the housing 201 of the electronic device. Such planar coil configurations 200 can be used for either power transfer or communication applications, provided that the corresponding coil is of a complementary size, shape, etc. as discussed in greater detail below with respect to FIGS. 3A-3C.

FIG. 2B illustrates an example of a post coil configuration 205, which includes two coil assemblies. A first coil assembly can include a winding 206 disposed about a magnetic core 207 as illustrated, and a second coil assembly can include a winding 208 disposed about a magnetic core 209. Windings 206/208 are illustrated as being wound around respective “posts” of the magnetic cores 207/209, hence the term post coil. As with the planar coil configuration 200 described above, magnetic cores 207/209 can be formed from a material having sufficient magnetic permeability to provide a desired level of flux steering and/or shielding of other devices from magnetic flux created by current flowing in the windings 206/208. Windings 206/208 can be wire wound coils, printed circuit coils, or other configurations that can provide the desired level of magnetic flux in response to the available current. Dimensions, wire size, number of turns, wire size, etc. can be selected based on the operating frequencies and power levels of a particular embodiment. In post coil configuration 205, a current flowing in one winding (e.g., winding 206) can induce a magnetic flux in magnetic core 207 that couples into magnetic core 209. The resulting flux in magnetic core 209 can induce a corresponding current in winding 208. The ratio of the current in winding 206 to the current in winding 208, as well as corresponding voltages and level of power transferred can be determined by the number of turns, the degree of coupling between the respective coils, etc. Such post coil configurations 205 can be used for either power transfer or communication applications, provided that the corresponding coil is of a complementary size, shape, etc. as discussed in greater detail below with respect to FIGS. 3A-3C.

FIGS. 3A-3C illustrate coil configurations and corresponding flux paths for wireless power transfer and/or communication applications. More specifically, FIG. 3A illustrates a dual planar coil configuration 300a. Dual planar coil configuration means that a wireless power receiver (Rx)/NFC listener includes a planar coil 311, and a wireless power transmitter (Tx)/NFC poller includes a corresponding planar coil 312. In terms of wireless power transfer, a wireless power receiver (Rx) is a device that receives wireless power from the wireless power transmitter; although in at least some embodiments bidirectional power transfer may be possible. In terms of wireless communication, particularly wireless communication using various NFC (near field communication) protocols, such as those promulgated by the NFC Forum, a poller refers to a device that interrogates a listener to establish NFC communication. As one example, a poller device might be a point of sale (POS) terminal, and a listener device may be an NFC tag or other NFC device used to provide payment to complete a transaction. Listener devices (and the associated circuitry, coils, etc.) may be built into devices such as NFC tags, credit/debit/payment cards, or electronic devices such as smartphones, smartwatches, etc. allowing for so-called “tap to pay” or similar “contactless” payments. Poller devices may be implemented in dedicated POS devices, or in some embodiments, electronic devices such as smartphones, tablet computers, etc. can use internal or external accessory NFC devices to provide the required coil(s), electronic circuitry, etc.

In any case, the wireless power transmitter coil 312 can be driven by suitable communication circuitry in the poller device to provide a current that induces a flux 313 that couples to the corresponding listener coil 311. As described above, this can induce a current in listener coil 311 that can be decoded by communication circuitry in the listener device to receive a polling message from the poller device. In response, the listener device can drive listener coil 311 with a current that induces a flux 313 that couples to the corresponding listener coil 311, which can in turn be decoded by communication circuitry in the poller device to receive a response message from the listener device. The resulting two-way communication can allow for various communications, transactions, etc. in a wide variety of applications. Similarly, as described above with reference to FIG. 1, a wireless power transmitter can use its drive circuitry to drive coil 312 with a current that induces a flux 313 that couples to coil 311. This in turn can induce a current that can be used to deliver power to the wireless power receiver, which can use circuitry coupled to coil 311 to convert the induced current into a suitable power supply voltage/current.

FIG. 3B illustrates a dual solenoid coil configuration 300b. Dual solenoid coil configuration means that a wireless power receiver (Rx)/NFC listener includes a solenoid coil including winding 321 wound in a solenoid configuration around magnetic core 327, and a wireless power transmitter (Tx)/NFC poller includes a corresponding solenoid coil including a winding 322 wound in a solenoid configuration around magnetic core 329. The solenoid configuration can be thought of as generally corresponding to the post configuration described above with respect to FIG. 2B. In the dual solenoid configuration 300b, operation can be generally as described above with respect to the dual planar coil configuration of FIG. 3A. That is, wireless power transmitter/NFC poller device can drive winding 308 with a current that induces a flux 323 in magnetic core 309. This flux 323 couples into magnetic core 307, which induces a corresponding current in winding 306. The reverse direction is equally applicable. As a result, communication and/or power transfer circuitry in the respective wireless power transmitter/NFC poller and wireless power receiver/NFC listener devices can communicate and or allow for power delivery generally as described above. In the illustrated example, the direction of flux 323 through the “right” posts of the respective magnetic cores/coils is in an “upward” direction, while the direction of flux 323 through the “left” posts of the respective magnetic cores/coils is in a “downward” direction. (Left, right, upward, and downward merely refer to the illustration of FIG. 3B, and do not necessarily imply any particular spatial orientation in a given embodiment.) As discussed in greater detail below, this can give rise to a potential issue if a planar coil wireless power receiver/NFC listener is used with a solenoid coil wireless power transmitter/NFC poller.

FIG. 3C illustrates a combined planar coil wireless power receiver/NFC listener used with a solenoid coil wireless power transmitter/NFC poller. The principles described below would apply equal to the opposite configuration, i.e., a solenoid coil wireless power receiver/NFC listener used with a planar coil wireless power transmitter/NFC poller. More specifically, the wireless power transmitter/NFC poller may induce a flux that includes a “positive” flux component 323a (corresponding to the “upward” flux in FIG. 3B) and a “negative” flux component 323b (corresponding to the “downward” flux in FIG. 3B). In this sense “positive” and “negative” are relative terms, and the respective flux components could be in either direction; however, the point is that the respective flux components can cancel each other out if they both pass through planar coil 311. Thus, a solenoid coil and planar coil may not be compatible if the respective sizes and configurations of the coils are not carefully selected and/or the relative positions of the coils are not carefully controlled to prevent the flux cancellation problem illustrated in FIG. 3C.

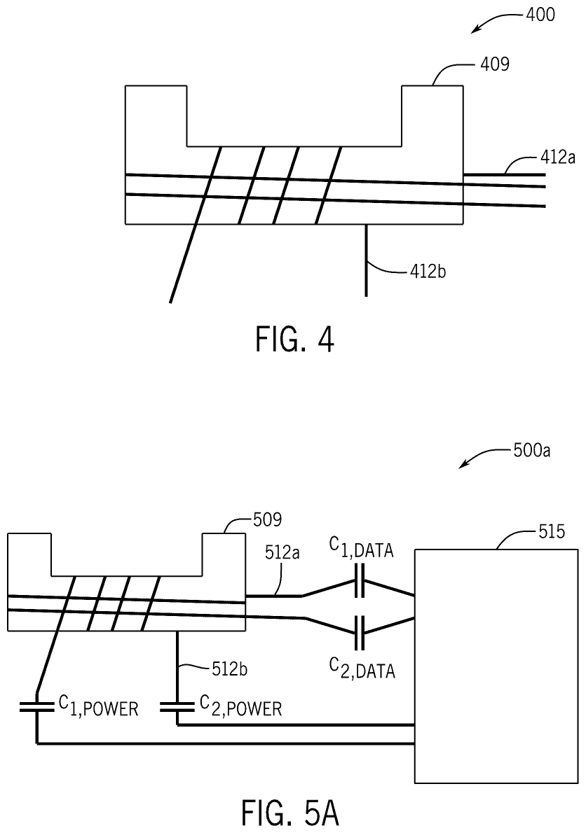

FIG. 4 illustrates a multi-winding coil configuration 400 that can mitigate the issues described above with respect to FIG. 3C. More specifically, multi-winding coil 400 can include a first winding with a first configuration to be used for communication (e.g., post winding 412a) and a second winding with a second configuration to be used for wireless power transfer (e.g., solenoid winding 412b) for wireless power transfer, arranged on a common magnetic core 409. Windings 412a and 412b can be constructed using wound wire, PCB windings, or other suitable winding structures as described above. Similarly, common magnetic core 409 can be constructed from a suitable ferromagnetic material, such as ferrite, as described above. The magnetic core dimensions, numbers of turns, winding size, and other properties of the multi-winding coil can be determined based on operating frequency(ies), power transfer levels, dimensional or volume restrictions, etc.

Depending on the requirements of a particular application, either of the above-described planar or post winding configurations could be employed for either communication or power transfer. However, for NFC listener devices that employ planar windings, the post winding configuration 412a can provide a suitable flux pattern when positioned within the housing of an electronic device. Similarly, for accessory devices such as a stylus, that employ NFC charging using a solenoid winding, the solenoid winding configuration 412b can provide a suitable flux pattern when positioned within the housing of an electronic device. For example, such a multi-winding coil configuration 400 could be positioned in the side of a tablet computer used as a POS terminal or similar device, allowing for NFC communication associated with the POS function as well as charging of a stylus or other device used for user input.

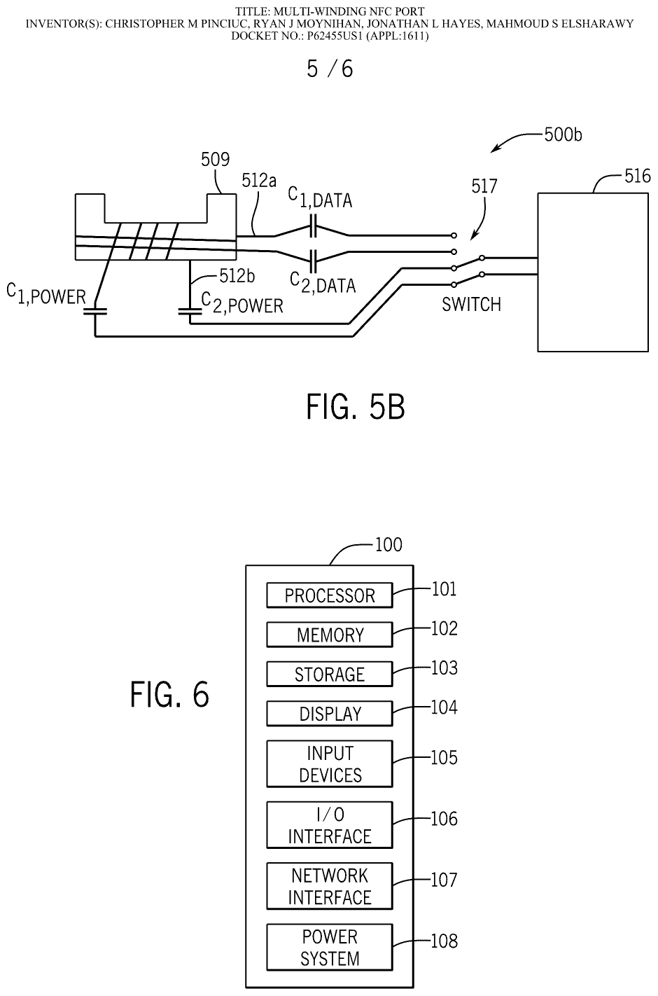

FIG. 5A illustrates a system 509 including a multi-winding coil as described above with respect to FIG. 4 coupled to a two-input controller chip 515. In some embodiments, controller chip 515 may be an NFC controller chip having a first input for NFC data communication and a second input for NFC charging/power delivery. However, NFC devices are just one exemplary application, and the principles described and illustrated herein may be applied to any dual-purpose communication/wireless power delivery system, even those employing technologies, techniques, or standards other than NFC. In any case, solenoid winding 512b, which may, for example, be used for power delivery (including but not necessarily limited to NFC power delivery) can be coupled to controller chip 515 by coupling capacitors C1,power and C2,power. Similarly, post winding 512a, which may, for example, be used for communication (including but not necessarily limited to NFC communication) can be coupled to controller chip 515 by coupling capacitors C1,data and C2,data.

Controller chip 515 can include various implementations of the power delivery control and communication circuitry described above with reference to FIG. 1. Additionally, in some embodiments (not shown) the communication circuitry and functionality could be implemented by a first controller (i.e., communication controller) and the power delivery circuitry and functionality could be provided by a second controller chip (i.e., power controller). In some applications, an optional communication path for communication between the respective controllers could be provided to allow for coordination of the use of the respective coils as described in greater detail below. Otherwise, such a configuration would be similar to that illustrated in FIG. 5A. In either the single controller or dual controller case, additional communication could be provided to an application processor or other processing system of an electronic device, as described in greater detail below with respect to FIG. 6.

FIG. 5B illustrates a multi-winding coil coupled to a single-input controller chip via a switch. In some embodiments, controller chip 516 may be an NFC controller chip having a single input for NFC data communication and NFC charging/power delivery. However, NFC devices are just one exemplary application, and the principles described and illustrated herein may be applied to any dual-purpose communication/wireless power delivery system, even those employing technologies, techniques, or standards other than NFC. In any case, solenoid winding 512b, which may, for example, be used for power delivery (including but not necessarily limited to NFC power delivery) can be coupled to controller chip 516 by coupling capacitors C1,power and C2,power via first terminals of switch 517. Similarly, post winding 512a, which may, for example, be used for communication (including but not necessarily limited to NFC communication) can be coupled to controller chip 515 by coupling capacitors C1,data and C2,data using second terminals of switch 517. As illustrated switch 517 is illustrated as being external with respect to controller chip 516; however, such switch could be implemented internally to controller chip 516. The switch can be controlled by controller chip 516 or by another processing system of an electronic device as described in greater detail below. In either case, controller chip 516 can include various implementations of the power delivery control and communication circuitry described above with reference to FIG. 1.

FIG. 6 is a block diagram of an electronic device 100, according to embodiments of the present disclosure. The electronic device 100 may include, among other things, one or more processors 101 (collectively referred to herein as a “processor” for convenience, which may be implemented in any suitable form of processing circuitry including homogenous multiprocessors, heterogenous multiprocessors, etc.), memory 102, nonvolatile storage 103, a display 104, input devices 105, an input/output (I/O) interface 106, a network interface 107, and a power system 108. The various functional blocks shown in FIG. 6 may include hardware elements (including circuitry), software elements (including machine-executable instructions), or a combination of both hardware and software elements (which may be referred to as logic). The processor 101, memory 102, the nonvolatile storage 103, the display 104, the input devices 105, the input/output (I/O) interface 106, the network interface 107, and/or the power system 108 may each be communicatively coupled directly or indirectly (e.g., through or via another component, a communication bus, a network, etc.) to one another to transmit and/or receive data amongst one another. It should be noted that FIG. 6 is merely one example of a particular implementation and is intended to illustrate the types of components that may be present in the electronic device 100.

By way of example, the electronic device 100 may include any suitable computing device, including a desktop or laptop/notebook, a portable electronic or handheld electronic device such as a wireless electronic device or smartphone, a tablet computer, a wearable electronic device such as a smart watch or head mounted display, and other similar devices.

Processor 101 and other related items in FIG. 6 may be embodied wholly hardware or by hardware programmed to execute suitable software instructions. Furthermore, the processor 101 and other related items in FIG. 6 may be a single contained processing module or may be incorporated wholly or partially within any of the other elements within the electronic device 100. Processor 101 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. Processor 101 may include one or more application processors, one or more baseband processors, or both, and perform the various functions described herein.

In the electronic device 100 of FIG. 6, processor 101 may be operably coupled with a memory 102 and a nonvolatile storage 103 to perform various algorithms. Such programs or instructions executed by processor 101 may be stored in any suitable article of manufacture that includes one or more tangible, computer-readable media. The tangible, computer-readable media may include the memory 102 and/or the nonvolatile storage 103, individually or collectively, to store the instructions or routines. The memory 102 and the nonvolatile storage 103 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by processor 101 to enable the electronic device 100 to provide various functionalities.

In certain embodiments, the display 104 may facilitate users to view images generated on the electronic device 100. In some embodiments, the display 104 may include a touch screen, which may facilitate user interaction with a user interface of the electronic device 100. Furthermore, it should be appreciated that, in some embodiments, the display 104 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input devices 105 of the electronic device 100 may enable a user to interact with the electronic device 100 (e.g., pressing a button to increase or decrease a volume level). The I/O interface 106 may enable the electronic device 100 to interface with various other electronic devices, as may the network interface 107. In some embodiments, the I/O interface 106 may include an I/O port for a hardwired connection for charging and/or content manipulation using a standard connector and protocol, such as a universal serial bus (USB), or other similar connector and protocol. The network interface 107 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 107 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 107 of the electronic device 100 may allow communication over the aforementioned networks (e.g., 5G, Wi-Fi, LTE-LAA, and so forth).

The network interface 107 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power system 108 of the electronic device 100 may include any suitable source of power, such as a rechargeable battery (e.g., a lithium ion or lithium polymer (Li-poly) battery) and/or a power converter, including a DC/DC power converter, an AC/DC power converter, a power adapter (which may be external), etc. The power system 108 can also include a wireless power transfer system as described above with respect to FIGS. 1-5B, including a wireless power transfer system based on NFC charging. Such a system may also include communication systems as described above, thus implementing some of the functionality of network interface 107 as well.

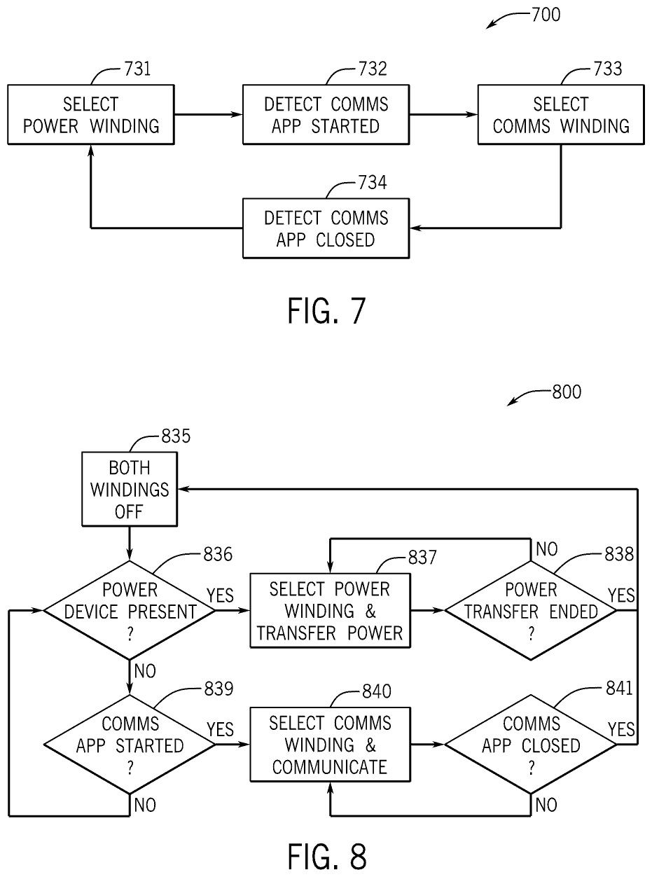

When using a dual-purpose communication/wireless power transfer system as described above, it may be desirable to selectively enable either the communication functionality or the wireless power transfer functionally. In some applications it may be desirable to enable only one functionality at a given time. For example, with either a dual input or single input controller (as described above with respect to FIGS. 5A and 5B), it may be desirable to selectively enable only one of the respective coil configurations at a given time. FIG. 7 illustrates a flow chart 700 of a first technique for selecting between a wireless power transfer winding and a wireless communication winding. The process represented by the flow chart can be performed by the communication/power transfer controller (e.g., controller 515, 516 and/or control circuitry 16, described above). One or more portions of the process can be performed by or in connection with the processor of the parent device, i.e., processor 101, described above. To that end, there may be a suitable communication link between such respective processors.

Beginning with block 731, the power winding can be selected as a “default.” That is, the power winding may be in operation in the baseline or initial condition. Thus, the wireless power transfer system can be periodically driving the wireless power transfer winding with suitable initialization signals and measuring the response of the wireless power transfer coil to determine whether a device to which power should be delivered is present. These types of processes are sometimes colloquially known as “pinging.” In such cases, the absence of a wireless power receiving device can be detected in the electrical response to the stimulus provided to the wireless power transfer winding. Likewise, the presence of a wireless power receiving device can also be detected by the differing response to the stimulus. More sophisticated techniques can also be employed to distinguish a wireless power receiver device from another object that may nonetheless electromagnetically interact as a result of the pinging operation. Such distinguishing techniques can rely on more complex analyses of measured change in electrical properties and/or in-band or out-of-band communication with the receiver initiated in response to an initially detected electrical property change. Techniques of this type are available to those skilled in the art, and thus will not be repeated here for the sake of brevity. In any case in which a receiver object is detected, the wireless power controller can initiate wireless power transfer to the wireless power receiver based on the appropriate wireless transfer protocol(s).

Alternatively, in block 732, if the system detects that a communication related application has been started on the device (e.g., on one or more processors 101 as described above), then the system can select the communication winding (block 733), which can also include disabling the power winding. Thereafter, in block 734, if the system detects that a communication related application has stopped on the device (e.g., on one or more processors 101 as described above), then the system can select the power winding (block 731), which can also include disabling the power winding. Detection of the opening or closing of an application calling for the use of the communications winding/system, can be based on communication between the wireless power transfer controller (e.g., control circuitry 16) and the processor 101 of the parent device. This could be implemented in a variety of ways, such as a software agent running on processor 101 that reports initiation of the communications application to the wireless power system control circuitry 16. Such a software agent could be implemented as part of the device operating system, a device driver, or in any of a variety of other forms.

FIG. 8 illustrates a flow chart 800 of a second technique for selecting between a wireless power transfer winding and a wireless communication winding. The process represented by the flow chart can be performed by the communication/power transfer controller (e.g., controller 515, 516 and/or control circuitry 16, described above). One or more portions of the process can be performed by or in connection with the processor of the parent device, i.e., processor 101, described above. To that end, there may be a suitable communication link between such respective processors.

Beginning with block 835, both windings can be “off,” meaning that neither the communication coil nor the power transfer coil is enabled or operating. Then in block 836, the system can determine whether a power device, i.e., a wireless power receiver device is present. This may be accomplished using some sensor that can detect the presence or proximity of a wireless power receiver device. For example, a magnetic sensor, such as a Hall effect sensor, could be used to detect a suitable magnet in the wireless power receiver device. Such sensing need not be limited to magnetic sensors, and other sensor types, such as capacitive presence sensors, load cells (for detecting the weight of a device), etc. could also be provided. In any case, once presence of a power device is detected in block 836, the power winding can be selected (block 837).

Thereafter, the wireless power transfer system can drive the wireless power transfer winding with suitable initialization signals and measuring the response of the wireless power transfer winding to confirm whether a device to which power should be delivered is present. As described above, suitable techniques can also be employed to distinguish a wireless power receiver device from another object that may nonetheless electromagnetically interact as a result of the pinging operation. Such distinguishing techniques can rely on more complex analyses of measured change in electrical properties and/or in-band or out-of-band communication with the receiver initiated in response to an initially detected electrical property change. Numerous such techniques are known to those skilled in the art, and thus will not be repeated here for the sake of brevity. In any case in which a receiver object is detected, the wireless power controller can initiate wireless power transfer to the wireless power receiver based on the appropriate wireless transfer protocol(s) (also in block 837). So long as the power transfer continues (i.e., is not detected as ended in block 838), the power winding can remain enabled. Once the end of power transfer is detected (block 838), the power winding can be disabled, leaving both windings off (block 835), which is the initial condition.

Returning to the discussion of block 836, if, alternatively, no presence of a power device is detected, the system can determine whether a communication application has started (block 839). If not, the system can alternate by checking for the presence of a power device (block 836) and checking for the startup of a communications application. If a communication application is started (Y branch off block 839), then the communications winding can be selected, and communication processes can be performed (block 840). Thereafter, the system can drive the communication winding with and/or detect therefrom suitable communication signals. So long as the communication transfer continues (i.e., is not detected as ended in block 841), the communication winding can remain enabled. Once the end of communication is detected (block 841), the communication winding can be disabled, leaving both windings off (block 835), which is the initial condition. As described above, detection of the opening or closing of an application calling for the use of the communications winding/system, can be based on communication between the communication controller (e.g., control circuitry 16) and the processor 101 of the parent device. This could be implemented in a variety of ways, such as a software agent running on processor 101 that reports initiation of the communications application to the control circuitry 16. Such a software agent could be implemented as part of the device operating system, a device driver, or in any of a variety of other forms.

Described above are various features and embodiments relating coil structures that can be used for power transfer and data communication in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A multiple winding coil comprising:
a magnetic core;
a first winding with a first configuration used for communication wound on the magnetic core; and
a second winding with a second configuration used for wireless power transfer also wound on the magnetic core.

2. The multiple winding coil of claim 1 wherein the first winding with a first configuration comprises a post winding wound around the magnetic core and the second winding with a second configuration comprises a solenoid winding wound around the magnetic core in a direction orthogonal to a direction of the post winding.

3. The multiple winding coil of claim 1 wherein the magnetic core is formed of ferrite.

4. The multiple winding coil of claim 1 wherein at least one of the first and second windings comprise wire wound windings.

5. The multiple winding coil of claim 1 wherein at least one of the first and second windings comprise printed circuit windings.

6. The multiple winding coil of claim 1 wherein the magnetic core, first winding, and second winding have dimensions selected to communicate and transfer power at one or more frequencies associated with a standard.

7. The multiple winding coil of claim 6 wherein the standard is a near field communication (NFC) standards promulgated by the NFC Forum.

8. The multiple winding coil of claim 7 wherein the one or more frequencies include 13.56 MHz.

9. The multiple winding coil of claim 1 wherein the magnetic core, first winding, and second winding have dimensions selected to communicate and transfer power at one or more frequencies associated with different standards.

10. A dual-purpose wireless power transfer and communication system configured to communicate and transfer power at one or more frequencies associated with near field communication (NFC) standards promulgated by the NFC Forum, the system comprising:
a magnetic core;
a first winding wound about the magnetic core in a post configuration to be used for communication; and
a second winding wound about the magnetic core in a post configuration to be used for wireless power transfer; and
at least one controller for wireless power transfer and communication coupled to the respective first and second windings.

11. The dual-purpose wireless power transfer and communication system of claim 10 wherein the at least one controller is a dual input controller having a first input coupled to the first winding and a second input coupled to the second winding.

12. The dual-purpose wireless power transfer and communication system of claim 10 wherein the at least one controller is a single input controller and the first and second windings are coupled to the single input by a switch.

13. The dual-purpose wireless power transfer and communication system of claim 12 wherein the switch is external to the at least one controller.

14. The dual-purpose wireless power transfer and communication system of claim 10 wherein the magnetic core, first winding, and second winding are configured to communicate and transfer power at 13.56 MHz.

15. The dual-purpose wireless power transfer and communication system of claim 10 wherein at least one of the first and second windings comprise wire wound windings.

16. An electronic device comprising:
one or more processors that execute a communication application;
a power system that includes a dual-purpose wireless power transfer and communication system configured to communicate and transfer power at one or more frequencies associated with near field communication (NFC) standards promulgated by the NFC Forum, the power system further comprising:
a magnetic core;
a first winding wound about the magnetic core in a post configuration to be used for communication; and
a second winding wound about the magnetic core in a post configuration to be used for wireless power transfer; and
at least one controller for wireless power transfer and communication coupled to the respective first and second windings;
wherein at least one of the one or more processors and the at least one controller selectively enable and disable the first and second windings to provide communication or power transfer functionality.

17. The electronic device of claim 16 wherein at least one of the processor and the at least one controller selectively enable and disable the first and second windings to provide communication or power transfer functionality by:
enabling the power winding;
upon detecting that a communication feature of an application has started on the processor, enabling the communications winding.

18. The electronic device of claim 17 wherein enabling the communications winding further comprises disabling the power winding and wherein the controller selectively enables and disables the first and second windings to provide communication or power transfer functionality by, upon detecting that a communication feature of the application has stopped on the processor, disabling the communications winding and re-enabling the power winding.

19. The electronic device of claim 18, further comprising a visual display operatively coupled to the one or more processors, wherein the visual display presents an visual indication that the electronic device is ready to provide communication functionality while the first winding is enabled.

20. The electronic device of claim 16 wherein at least one of the processor and the at least one controller selectively enable and disable the first and second windings to provide communication or power transfer functionality by:
determining whether a wireless power receiver is present;
determining whether a communications application has started on the processor;
responsive to determining that a wireless power receiver is present:
enabling the power winding;
engaging in power transfer; and
upon completion of power transfer, disabling the power winding; and
responsive to determining that a communication application has started on the processor:
enabling the communication winding;
engaging in communication; and
upon completion of communication, disabling the communication winding.

21. The electronic device of claim 16 wherein the magnetic core, first winding, and second winding are configured to communicate and transfer power at 13.56 MHz.

22. The electronic device of claim 16 wherein the electronic device is a tablet computer.

23. The electronic device of claim 16 wherein the wireless power receiver is a stylus.
